(19) United States
(12) Patent Application Publication
(10) Pub. No.: US 2026/0330007 A1
(43) Pub. Date: Oct. 22, 2026

(54) Secure Isolated Diagnostic Execution Environment

(71) Applicant: Brian Corlett, Nuremberg (DE)

(72) Inventor: Brian Corlett, Nuremberg (DE)

(21) Appl. No.: 19/651,963

(22) Filed: Apr. 20, 2026

(51) Int. Cl. G06F 21/53; G06F 21/57; G06F 21/64

(52) U.S. Cl. CPC G06F 21/53; G06F 21/572; G06F 21/64

(57) ABSTRACT

A secure, isolated diagnostic execution environment is disclosed for computing systems. The apparatus operates outside the host operating system, typically anchored to a pre-OS or firmware context and establishes a cryptographically verifiable trust boundary separating diagnostic operations from untrusted host components. Through a protected bootstrapping or provisioning mechanism, the system enables execution of diagnostic modules in controlled isolation, independent of any operating system or driver influence. Hardware-anchored or hardware-verified telemetry is acquired through trusted pathways that bypass OS interrupt vectors and kernel handlers, ensuring authenticity of system-state data. Diagnostic results are produced in a tamper-resistant, verifiable format anchored to or interoperable with hardware trust mechanisms. The architecture provides a vendor-agnostic foundation for reliable diagnostics across diverse platforms, enabling trustworthy analysis even in compromised or high-risk environments.

### 2. SUMMARY

Conventional diagnostic utilities operate within the same software environment they evaluate, allowing compromised operating systems, drivers, or firmware to distort diagnostic behavior and results. This dependency prevents reliable system assessment in high-assurance or security-sensitive contexts.

The disclosed architecture introduces a Secure Isolated Diagnostic Execution Environment (SIDEE) that operates entirely within a pre-operating-system firmware context, establishing a cryptographically verifiable trust boundary that separates diagnostic operations from untrusted host components. Through a protected bootstrapping mechanism, SIDEE validates its integrity before any host software is active. Diagnostic modules execute within controlled isolation governed by a standardized interface that enforces integrity, permissions, and resource separation.

System-state information is acquired exclusively through trusted firmware-level and hardware-level pathways that bypass OS interrupt vectors and kernel handlers. Diagnostic results are produced in a tamper-resistant, verifiable format anchored to hardware trust mechanisms. The architecture is vendor-agnostic and extensible, supporting diverse deployment models—from OEM firmware diagnostics to enterprise endpoint integrity verification—while ensuring trustworthy analysis even in compromised or high-risk environments.

### 3.

### DETAILED DESCRIPTION

### 3.1 System Architecture Overview

The Secure Isolated Diagnostic Execution Environment (SIDEE) establishes a pre-operating-system diagnostic layer that functions independently of any host software. The architecture is anchored by a protected bootstrapping mechanism that verifies integrity before activation and constructs a cryptographically verifiable trust boundary separating diagnostic operations from untrusted components.

### [FIG. 1—System Architecture Overview]

Within this boundary, diagnostic modules execute under the control of a Shadow Execution Controller that governs initialization, validation, execution, and teardown. The controller enforces strict isolation between modules and restricts resource access according to a standardized interface defining permissions and telemetry scope. Each module operates in a deterministic, time-bounded context and cannot persist state beyond its execution cycle.

System-state information is acquired exclusively through trusted firmware-level and hardware-level pathways. These pathways bypass operating-system interrupt vectors and kernel handlers, obtaining telemetry directly from hardware counters, firmware service calls, or TPM-anchored measurements. The resulting data is validated for integrity before use, ensuring that diagnostic analysis is based solely on authentic system conditions.

Diagnostic results are produced in an append-only, cryptographically linked format that supports authenticity and tamper detection. Each output record may include timestamps, module identifiers, and verification metadata anchored to hardware trust mechanisms. The apparatus's design prevents host software from intercepting or altering diagnostic data at any stage.

The invention's architecture is vendor-agnostic and extensible. It supports integration across diverse firmware implementations and hardware platforms while maintaining consistent trust-boundary enforcement. The apparatus provides a foundational layer for secure diagnostics in enterprise, OEM, and high-assurance deployments, enabling reliable system evaluation even when host components are compromised.

Operational Sequence. Upon trigger detection, the processor transitions into the isolated execution mode, instantiates the shadow execution controller, and performs out-of-band telemetry acquisition through hardware bypass channels. After diagnostics complete, the controller executes deterministic teardown and returns control to the host.

### 3.2 Operational Flow

The Secure Isolated Diagnostic Execution Environment (SIDEE) operates through a defined sequence that ensures integrity from initialization to teardown. Each stage is governed by the Shadow Execution Controller and enforced within the established trust boundary.

Initialization and Trust Establishment. The environment is invoked through hardware triggers, firmware pathways, secure remote commands, or automated integrity responses. A protected bootstrapping sequence verifies firmware and hardware integrity, constructs the cryptographically verifiable trust boundary, and activates the isolation context before any host software is loaded.

### [FIG. 2—Protected Bootstrapping Sequence]

Module Validation and Execution. Diagnostic modules are discovered, registered, and validated through signature checks, hash comparison, and permission evaluation. Only modules listed in the integrity-protected whitelist registry are permitted to execute. Each validated module operates within a deterministic, time-bounded context under the controller's supervision, ensuring isolation from other modules and from host components.

### FIG. 3—Shadow Execution Controller Lifecycle

Trusted Telemetry Bypass Sequence. System-state information is acquired through trusted firmware-level and hardware-level pathways that bypass operating-system interrupt vectors and kernel handlers. Telemetry is collected directly from hardware counters, firmware service calls, or TPM-anchored measurements. The Shadow Execution Controller validates the integrity of the acquired data before diagnostic use, preventing host software from intercepting or altering telemetry.

### [FIG. 4—Trusted Telemetry Bypass Pathways]

Trigger Categories for Diagnostic Activation. Execution may be initiated by one or more hardware-level triggers, including timing irregularities, checksum mismatches, attestation discrepancies, unexpected interrupt patterns, or structural inconsistencies in firmware-reported state. These triggers are evaluated within the isolation context to determine whether diagnostic execution is warranted.

### [FIG. 5—Trigger Categories and Activation Flow]

Result Generation and Verification. Each module produces deterministic diagnostic results in an append-only, cryptographically linked format. Outputs include timestamps, module identifiers, and verification metadata anchored to hardware trust mechanisms. The format ensures authenticity and tamper detection.

Session Termination. Upon completion, the controller securely destroys all execution contexts, purges temporary data, invalidates the trust boundary, and returns control to the system without exposing internal mechanisms. This deterministic teardown guarantees that no residual state persists beyond the diagnostic session.

### 3.3—Diagnostic Module Lifecycle

Each diagnostic module within SIDEE follows a controlled lifecycle governed by the Shadow Execution Controller. The lifecycle ensures that every module operates with verified integrity, defined permissions, and deterministic teardown.

### [FIG. 6—Diagnostic Module Lifecycle]

Module Introduction. Modules may originate from built-in diagnostics, OEM packages, enterprise sources, or validated third parties. Upon introduction, each module is registered with associated metadata describing its identity, version, and required telemetry scope. Registration occurs within the isolation context and is subject to whitelist verification.

Module Validation. Before execution, the controller performs signature checks, hash comparisons, and authenticity validation. Permission evaluation determines which system resources and telemetry channels the module may access. Validation results are recorded within the integrity registry to prevent unauthorized reuse or modification.

Module Execution. Validated modules execute in isolated contexts under the controller's supervision. Resource access is restricted to trusted firmware-level and hardware-level pathways that bypass operating-system interrupt vectors. System-state queries are routed through the trusted telemetry pathway, ensuring that all diagnostic data originates from authenticated sources. Execution is deterministic and time-bounded, preventing persistence or interference between modules.

Module Output. Each module produces diagnostic results in a consistent, verifiable format. Outputs include timestamps, module identifiers, and cryptographic integrity markers. The append-only structure ensures authenticity and tamper detection. Results may be transmitted to secure storage or enterprise systems through firmware-controlled channels.

Module Teardown. Upon completion, the controller securely destroys the execution context, purges temporary data, and invalidates transient credentials. Metadata describing the execution outcome is recorded for auditing or compliance. The teardown process guarantees that no residual state or diagnostic artifacts remain accessible to host components.

### 3.4 Security Model

The Secure Isolated Diagnostic Execution Environment employs a layered security model that ensures integrity, authenticity, and resistance to tampering throughout the diagnostic process. Each layer operates within the cryptographically verifiable trust boundary established during protected bootstrapping.

### [FIG. 7—Security Model Layers]

Trust Boundary Enforcement. The trust boundary separates diagnostic operations from untrusted host components and validates all inputs before use. It restricts resource access to firmware-controlled and hardware-verified channels, preventing any influence from the operating system, drivers, or user-mode processes.

Isolation Mechanisms. Execution isolation is maintained by the Shadow Execution Controller, which governs module lifecycle and resource allocation. Each diagnostic module operates in a discrete, time-bounded context with no shared memory or persistent state. Cross-module interference and unauthorized resource access are prevented by design.

Data Integrity and Authenticity. System-state data is acquired through trusted telemetry pathways that bypass OS interrupt vectors and kernel handlers. All telemetry is validated for consistency and authenticity using cryptographic checks or TPM-anchored measurements before diagnostic use.

Module Integrity and Permissions. Modules must pass signature verification, hash comparison, and permission evaluation before execution. The whitelist registry defines permissible modules and their telemetry scope, ensuring that only validated components operate within the isolation context.

Output Protection and Audit Logging. Diagnostic results are produced in an append-only, cryptographically linked format. Each entry includes timestamps, module identifiers, and integrity markers anchored to hardware trust mechanisms. The audit log is generated within the isolation context and cannot be modified by host software, providing a tamper-evident record of diagnostic activity.

Threat Resistance. The architecture resists compromised operating systems, malicious drivers, firmware manipulation, unauthorized modules, and falsified diagnostics. By enforcing deterministic teardown and hardware-anchored verification, SIDEE maintains diagnostic integrity even under adversarial conditions.

### 3.5 Example Implementations

### [FIG. 8—Example Implementation Contexts]

Enterprise Endpoint Diagnostics. In large-scale enterprise environments, SIDEE enables remote, tamper-resistant diagnostics even when operating systems are compromised.

OEM Pre-Boot Diagnostics. Integrated directly into firmware, SIDEE performs reliable diagnostics when storage devices or operating-system components are corrupted.

Secure Remote Support. Technicians may invoke SIDEE through secure remote commands to obtain authentic system telemetry unaffected by malware or user-space interference.

High-Assurance Environments. SIDEE supports aviation, medical, industrial, and other safety-critical systems requiring verifiable integrity.

Automated Integrity Response. The environment may activate automatically when suspicious activity is detected.

Forensic Triage and Incident Response. SIDEE provides a trusted pre-OS environment for post-incident analysis.

Supply-Chain Assurance and First-Boot Verification. SIDEE validates hardware, firmware, and configuration before the first operating-system boot.

Zero-Trust Endpoint Onboarding. SIDEE performs pre-OS integrity verification before network access is granted.

### 3.6 Alternative Embodiments

### [FIG. 9—Alternative Embodiment Variants]

Hardware-Anchored Variant. SIDEE operates within a hardware-enforced isolated execution mode such as SMM, a secure enclave, or an embedded controller context.

Firmware-Resident Variant. SIDEE may operate entirely within firmware.

Network-Isolated Variant. SIDEE may function without network connectivity.

Cloud-Assisted Variant. SIDEE may offload non-sensitive computation to secure remote services.

Minimalist Variant. A reduced-footprint configuration may be used for constrained devices. Extended-Module Variant. SIDEE may support enterprise-specific or third-party diagnostic modules under strict validation.

### 4. Claims

(Claims provided as a standalone document.)

### 5. Definitions

5.1 Trust Boundary. A cryptographically verifiable separation between trusted diagnostic operations and untrusted system components. The boundary validates all inputs, restricts resource access, and prevents host software from influencing diagnostic behavior.
5.2 Protected Bootstrapping. A secure initialization sequence that verifies firmware and hardware integrity before establishing the trust boundary. This process ensures that diagnostic execution begins only within a validated environment.
5.3 Diagnostic Module. A discrete executable component performing a specific diagnostic function within the isolated environment. Each module operates under defined permissions and integrity constraints enforced by the standardized interface.
5.4 Trusted System-State Acquisition. Retrieval of system information through firmware-level or hardware-level channels insulated from host operating-system influence. Telemetry obtained through these pathways is validated for authenticity and consistency before diagnostic use.
5.5 Verifiable Output. Diagnostic results produced in an append-only, cryptographically linked format that supports authenticity and tamper detection. Each output record includes timestamps, module identifiers, and integrity markers anchored to hardware trust mechanisms.
5.6 Isolation Context. A controlled execution context preventing interference between modules or from untrusted components. The isolation context is created and destroyed deterministically under the supervision of the Shadow Execution Controller.

### 6. Glossary of Defined Terms

6.1 Secure Isolated Diagnostic Execution Environment (SIDEE). A hardware-anchored diagnostic apparatus operating within a protected execution mode such as System Management Mode (SMM), a secure enclave, or an embedded controller context. SIDEE provides isolation from all firmware and software layers of the host system.
6.2 Shadow Execution Controller. A hardware-resident control component executing inside the isolated execution mode. It manages initialization, validation, telemetry acquisition, and deterministic teardown of diagnostic modules.
6.3 Isolation Context. A protected diagnostic space created and destroyed under the supervision of the Shadow Execution Controller. It prevents interference between modules and untrusted host components.
6.4 Integrity Registry. A hardware-anchored data store maintaining baseline telemetry, timing profiles, and attestation keys used for comparison and validation during diagnostic operations.
6.5 Deterministic Teardown. A controlled sanitization process that overwrites all registers, buffers, and volatile memory regions associated with the isolation context using randomized bit patterns before returning control to the host environment.
6.6 Append-Only Ledger. A cryptographically linked ledger of diagnostic results in which each entry is chained to its predecessor, ensuring immutability and forensic verifiability.
6.7 Hardware-Anchored Variant. An embodiment of SIDEE in which all diagnostic operations occur within a hardware-enforced isolated execution mode, guaranteeing independence from firmware and software components.

### 7. Advantages

The Secure Isolated Diagnostic Execution Environment (SIDEE) provides multiple advantages over conventional diagnostic systems. The following technical advantages illustrate how SIDEE improves computer security architecture and diagnostic integrity:
Integrity and Trustworthiness. Diagnostics are executed within a cryptographically verified isolation context anchored to hardware attestation keys. This ensures that telemetry and results remain authentic even under compromised firmware, drivers, or user-mode processes.
Deterministic Lifecycle. Each diagnostic module follows a defined initialization-execution-teardown sequence enforced by the shadow execution controller, preventing residual state persistence and guaranteeing repeatable outcomes.
Tamper-Resistant Output. Diagnostic results are recorded in an append-only cryptographically linked ledger, enabling forensic verification of every entry without external trust assumptions.
Operational Sequence. Upon trigger detection, the processor transitions into the isolated execution mode, instantiates the Shadow Execution Controller, and performs out-of-band telemetry acquisition through hardware bypass channels. After diagnostics complete, the controller executes deterministic teardown and returns control to the host.

### 8. Conclusion

The Secure Isolated Diagnostic Execution Environment (SIDEE) provides a novel architecture for performing trustworthy diagnostics independent of host software integrity.

By establishing a cryptographically verifiable trust boundary, enforcing isolation through a controlled execution context, and acquiring telemetry through trusted firmware-level and hardware-level pathways, SIDEE ensures diagnostic authenticity even in compromised environments. The disclosed embodiments demonstrate that reliable system evaluation can be achieved without reliance on operating-system components or external tools. The architecture's deterministic operation, tamper-resistant output, and vendor-agnostic extensibility enable deployment across diverse platforms and security domains. While specific embodiments have been described, variations and modifications consistent with the disclosed principles may be implemented without departing from the scope of the invention as defined by the claims. The invention therefore provides a foundational mechanism for secure, independent diagnostics applicable to a wide range of computing systems. This architecture is implemented within a hardware-enforced isolated execution mode, ensuring independence from all firmware and software layers.

### DRAWINGS

FIG. 1—System Architecture Overview

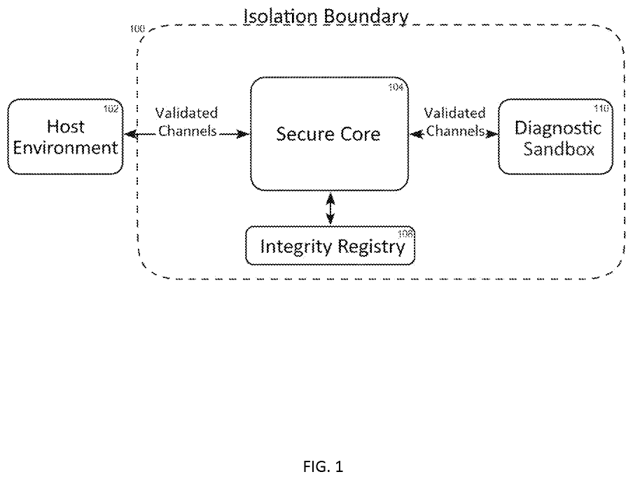

FIG. 2—Protected Bootstrapping Sequence

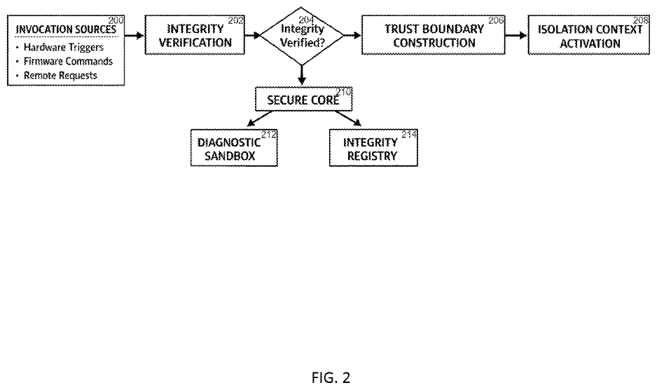

FIG. 3—Shadow Execution Controller Lifecycle

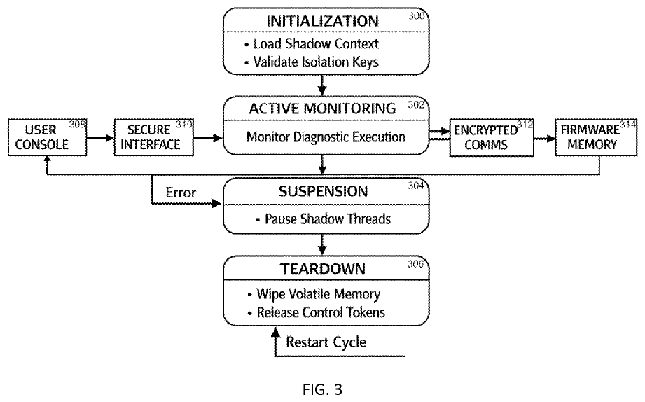

FIG. 4—Trusted Telemetry Bypass Pathways

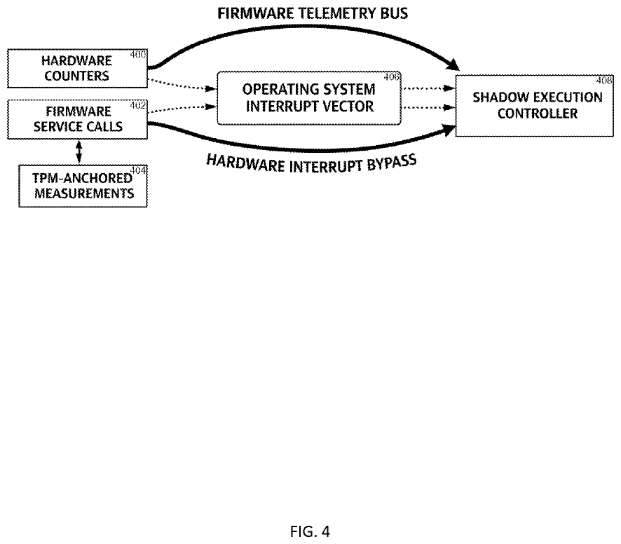

FIG. 5—Trigger Categories and Activation Flow

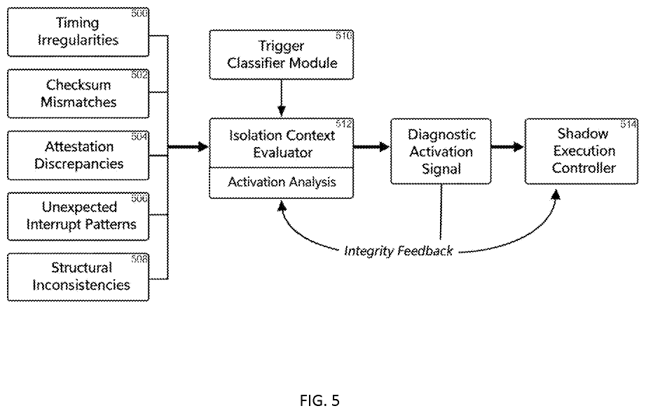

FIG. 6—D iagnostic Module Lifecycle

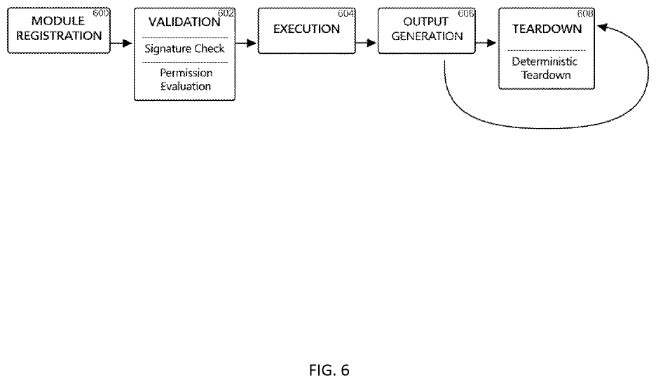

FIG. 7—-S ecurity Model Layers

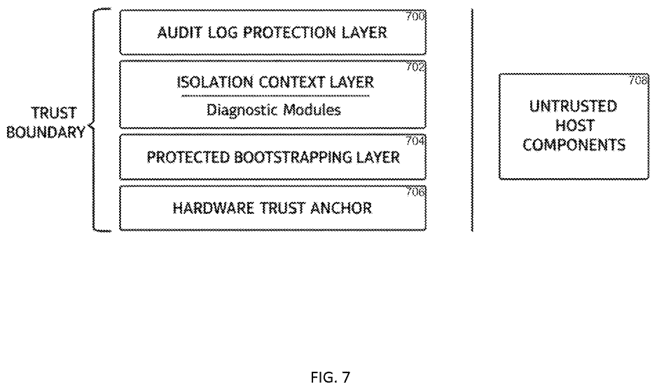

FIG. 8—E xample Implementation Contexts

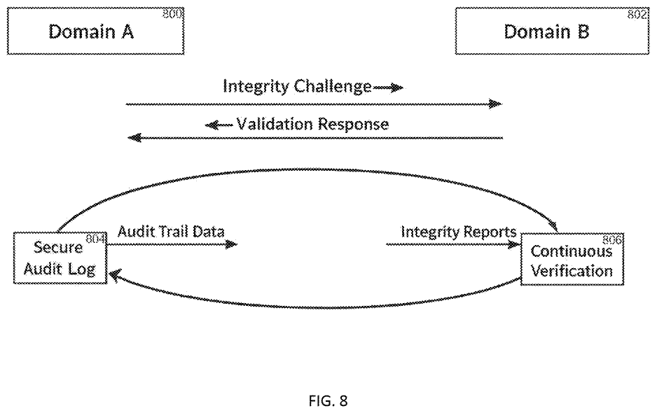

FIG. 9—A lternative Embodiment Variants

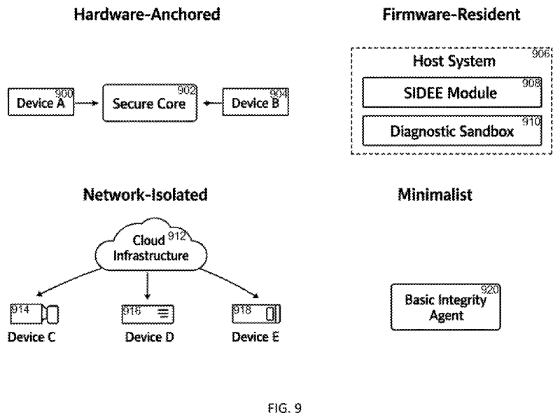

1. A secure diagnostic execution apparatus comprising: a processor configured to enter a hardware-enforced isolated execution mode selected from System Management Mode (SMM), a secure enclave, or an equivalent processor-resident context; a memory region reserved exclusively for said isolated execution mode; and a shadow execution controller executing within the isolated execution mode and configured to:
1. perform protected bootstrapping by authenticating firmware using a hardware-anchored trust anchor prior to initializing any diagnostic module;
2. establish an isolation context for executing one or more diagnostic modules, the isolation context being inaccessible to an operating system of a host computing environment;
3. receive telemetry via a hardware interrupt bypass path that directly interrogates hardware counters, sensors, or buses while bypassing operating-system interrupt vectors, kernel handlers, and software-mediated telemetry paths;
4. evaluate trigger conditions comprising timing irregularities, attestation discrepancies, unexpected interrupt patterns, or deviations from baseline measurements stored in an integrity registry;
5. execute diagnostic modules within the isolation context in response to the trigger conditions;
6. generate diagnostic output in an append-only, cryptographically linked format such that each entry is chained to a previous entry to prevent modification or reordering; and
7. perform deterministic teardown by, in part or wholly, deleting all volatile execution state associated with the isolation context prior to returning control to the host computing environment.

2. The apparatus of claim 1, wherein the trust boundary validates all inputs against a hardware-anchored integrity registry and restricts access to system resources outside the isolated execution mode.

3. The apparatus of claim 1, wherein each diagnostic module executes within a sandboxed isolation context governed by the shadow execution controller.

4. The apparatus of claim 1, wherein system-state information is obtained through firmware-verified telemetry channels that bypass operating-system interrupt vectors.

5. The apparatus of claim 1, wherein diagnostic results are cryptographically signed and chained using a hash-linked ledger structure to ensure authenticity and integrity.

6. The apparatus of claim 1, wherein the shadow execution controller compares interrupt-timing patterns against baseline measurements stored in the integrity registry to detect timing irregularities.

7. The apparatus of claim 1, wherein deterministic teardown includes in part or wholly deleting volatile memory regions and resetting transient execution state to ensure no usable temporary diagnostic data persists beyond the execution cycle.

8. The apparatus of claim 1, wherein the append-only diagnostic output is transmitted to a remote attestation service for enterprise-scale verification.

9. The apparatus of claim 1, wherein the isolated execution mode further comprises a cloud-assisted analysis variant configured to extend diagnostic evaluation beyond local hardware boundaries.
